(19) United States
(12) Patent Application Publication
(10) Pub. No.: US 2008/0110012 A1
(43) Pub. Date: May 15, 2008

(54) Z-axis fiber impregnation

(76) Inventor: Charles P. Bingham, Lighthouse Point, FL (US)

Correspondence Address: J. WILEY HORTON, ESQUIRE;Pennington, Moore, Wilkinson, Bell & Dunbar, P.A., Post Office Box 10095, (215 S. Monroe Street, 2nd Floor), Tallahassee, FL, 32302-2095, US

(21) Appl. No.: 11/983,694

(22) Filed: Nov. 9, 2007

Related U.S. Application Data
(60) Provisional application No. 60/858,378, filed on Nov. 9, 2006.

(51) Int. Cl. B23P 17/00

(52) U.S. Cl. 29/592

(57) ABSTRACT

A method for strengthening a laminate composite material having layers of fiber mats in the X-Y plane. The present method accomplishes this objective by impregnating the layers of fiber mats with strands of fibers in the Z direction. In the preferred embodiment, the impregnation is accomplished by using a “shooter” to pierce fiber strands through the layer of fiber mats.

### CROSS-REFERENCES TO RELATED APPLICATIONS

This application claims the benefit of the filing date of U.S. Application No. 60/858,378 which names the same inventor. The prior application was filed on Nov. 9, 2006.

### STATEMENT REGARDING FEDERALLY SPONSORED RESEARCH OR DEVELOPMENT

Not Applicable

### MICROFICHE APPENDIX

Not Applicable

### BACKGROUND OF THE INVENTION

1. Field of the Invention

This invention relates to the field of polymer composite materials. More specifically, this invention comprises a method of cross-linking a laminate structure in the Z direction, by inserting fibers which are primarily oriented in the Z direction.

2. Description of the Related Art

Polymer composite materials are increasingly being utilized for structural materials, particularly in high temperature and high stress applications. These composite materials are typically produced by layering sheets of carbon fiber cloth into a mold in the shape of the final product. The direction and weave pattern of the cloth fibers is important for the strength of the resulting material. Laminate composite materials are very strong in the direction of the fiber but are substantially weaker in the planes between the layers. Resin bonding alone holds the layers together, and the resin bonds holding the layers together are significantly weaker than in the fiber reinforced laminate planes. Under extreme operating conditions, the layers may delaminate because of the weakness of the resin bonds.

### BRIEF SUMMARY OF THE INVENTION

The present invention is a method for strengthening a laminate composite material having layers of fiber mats in the X-Y plane. The present method accomplishes this objective by impregnating the layers of fiber mats with strands of fibers in the Z direction. In the preferred embodiment, the impregnation is accomplished by using a “shooter” to pierce fiber strands through the layer of fiber mats.

### BRIEF DESCRIPTION OF THE SEVERAL VIEWS OF THE DRAWINGS

FIG. 1 is a perspective view, illustrating two fiber mats impregnated with fiber strands in the Z direction.

FIG. 2 is a perspective view, illustrating three fiber mats impregnated with fiber strands in the Z direction.

FIG. 3 is a perspective view, illustrating four fiber mats impregnated with fiber strands in the Z direction.

FIG. 4 is a perspective view, illustrating four fiber mats impregnated with fiber strands in the Z direction.

FIG. 5 is a section view, illustrating a shooter for impregnating fiber strands in the Z direction.

FIG. 6 is a perspective view, illustrating a nozzle.

FIG. 7 is a perspective view, illustrating a shooter for impregnating fiber strands in the Z direction.

FIG. 8 is a section view, illustrating a shooter for impregnating fiber strands in the Z direction.

### REFERENCE NUMERALS IN THE DRAWINGS

| | | | |
|---|---|---|---|
| 10 | cloth | 12 | cloth |
| 14 | fibers | 16 | cloth |
| 18 | fibers | 20 | fibers |
| 22 | cloth | 24 | chamber |
| 26 | funnel | 28 | conduit |
| 30 | port | 32 | alignment plate |
| 34 | fibers | 36 | nozzle |
| 38 | chopped fibers | 40 | hopper |
| 42 | inlet | 44 | manifold |
| 46 | shooter | 48 | shooter |
| 50 | fluid feed line | 52 | discharge ports |
| 54 | hopper | 56 | fiber discharge tubes |
| 58 | chopped fibers | 60 | fluid feed tube |

### DETAILED DESCRIPTION OF THE INVENTION

The present invention is a method for strengthening laminate composites to prevent delamination of the layers. This strengthening is accomplished by linking the layers of fabric with strands of fibers in the perpendicular direction. Once the layers are impregnated with the transverse fibers, the “vertically-reinforced” laminate structure is then subjected to resin infusion and allowed to cure. Many different molding techniques may be used to produce structural materials using the proposed vertically-reinforced laminate structure, including vacuum assisted resin transfer molding. Since these methods are well understood by those that are skilled in the art, a more thorough discussion of these molding techniques is omitted herein. Instead, the present disclosure focuses on a method for preparing a vertically-reinforced laminate structure that is resistant to delamination.

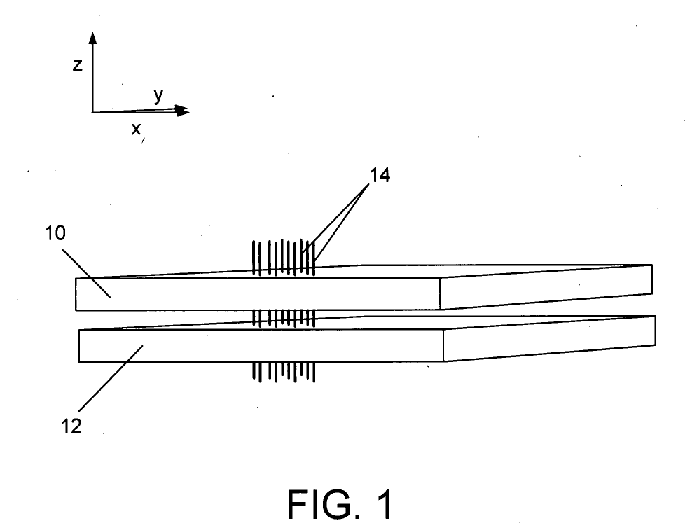

As illustrated in FIG. 1, two layers of carbon fiber matting (cloth 10 and cloth 12) are first aligned and “impregnated” with fibers 14. Cloth 10 and cloth 12 may be a weave of carbon fiber or other structural material. The reader will note that a small space is allowed between cloth 10 and cloth 12. The size of this space may vary depending upon the thickness of each layer that is required for the specific application of the composite material.

Cloth 10 and cloth 12 extend in two X-Y planes, and fibers 14 pierce each cloth in a perpendicular direction or in the direction of the Z axis although all of the fibers may not actually be perfectly aligned with the Z axis. Although fibers 14 are shown as impregnating only a small portion of cloth 10 and cloth 12, fibers 14 preferably impregnate cloth 10 and 12 in a uniformly distributed manner across the surfaces of cloth 10 and cloth 12. The reader will also note that the concentration of Z fibers (the quantity of impregnated fibers per square inch) may be varied depending on the amount of vertical reinforcement needed for a specific application.

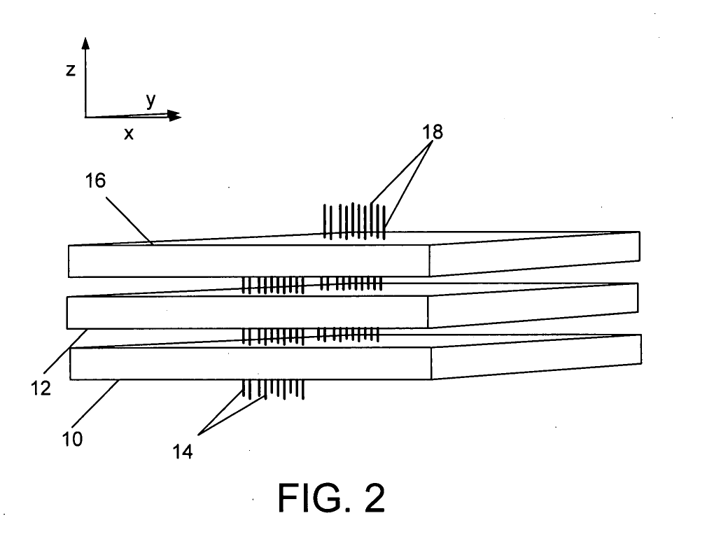

Once the first two layers of carbon fiber matting are vertically reinforced, a third layer of carbon fiber matting is then joined to the other two layers as illustrated in FIG. 2. Cloth 16 is positioned above cloth 12, and fibers 18 are then pierced through cloth 16 and cloth 12. Fibers 18 may or may not also pierce cloth 10. As with fibers 14, fibers 18 are preferably uniformly distributed throughout the surface of cloth 16 and cloth 12.

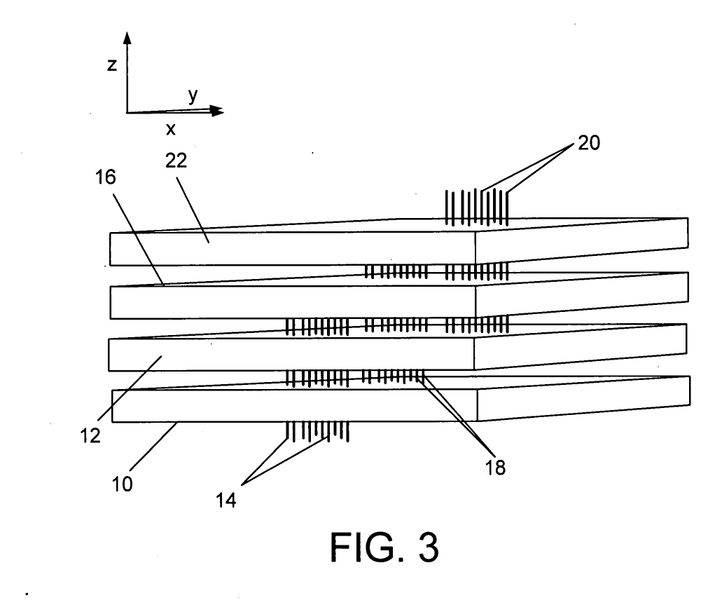

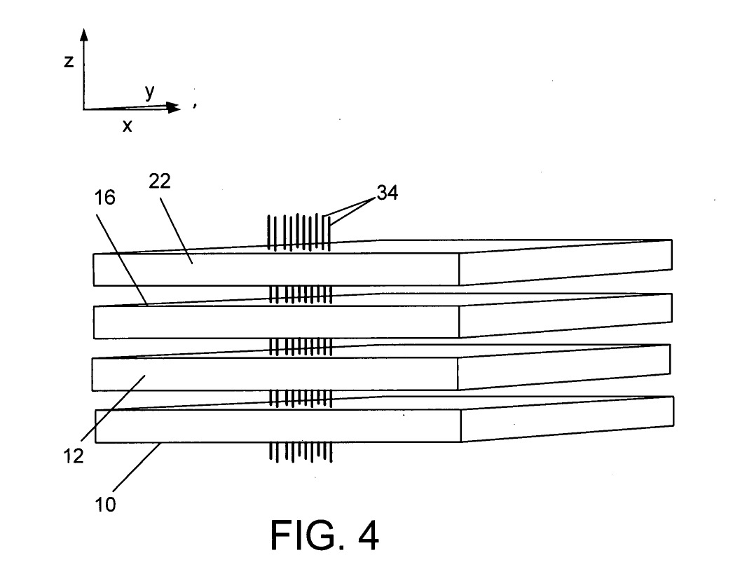

A fourth layer of carbon fiber matting is then joined to the other three layers as illustrated in FIG. 3. Cloth 22 is positioned above cloth 16, and fibers 30 are then pierced through cloth 22 and cloth 16. Fibers 20 may or may not also pierce cloth 12 and cloth 10. Additional layers of reinforcing fabric may be added as necessary. Alternatively, as illustrated in FIG. 4, longer fibers 34 may be used to impregnate three or more layers at a time instead of using the layer-by-layer lamination approach illustrated in FIGS. 1-3.

The reader will note that the perpendicular fibers provide strength in the Z direction comparable to that provided by the layers of structural fabric in the X and Y directions. Accordingly, this vertical reinforcement may strengthen a traditional laminate composite material by binding the layers with the added strength of the fibers instead of just the resin. This is particularly significant in many industries, including the aerospace industry, where delamination of layers is a critical limitation of many structural composite materials.

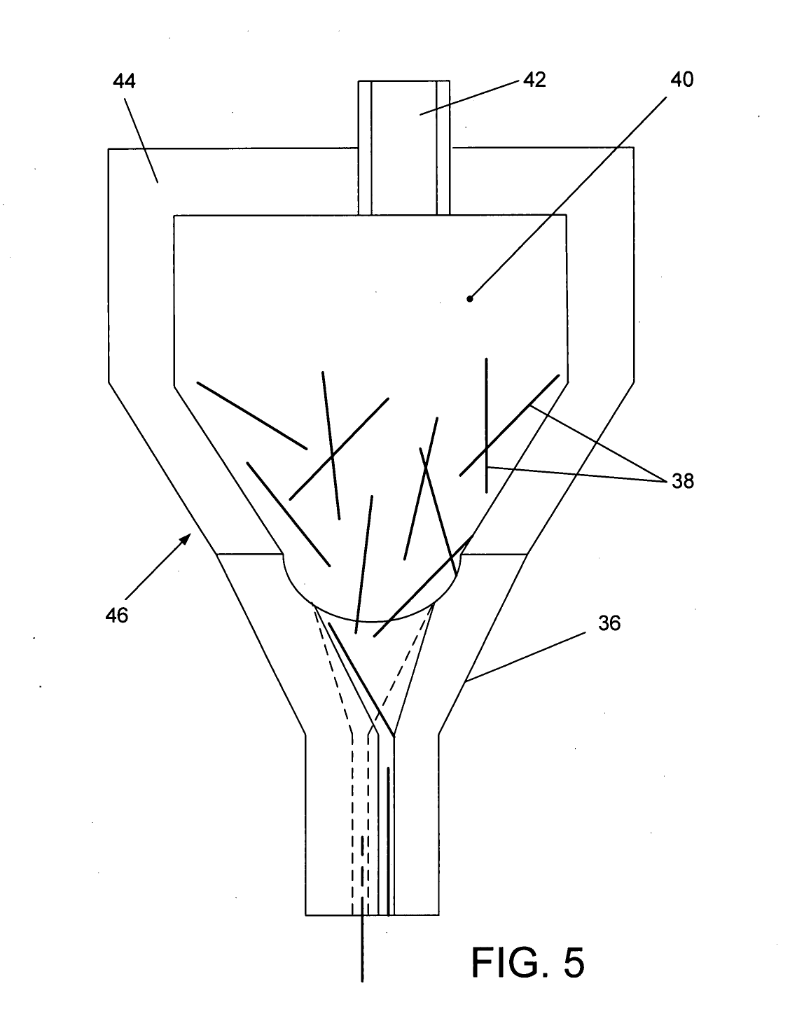

The impregnation of carbon fiber matting with fibers perpendicular to the cloth plane may be accomplished in many ways. In the preferred embodiment, a “shooter” is used to expel lengths of fiber with enough force to penetrate the weaves of cloth to a desired depth. An example of such a shooter is illustrated in FIG. 5. Shooter 46 includes nozzle 36 which attached to the bottom of manifold 44. Hopper 40 contains a plurality of chopped fibers 38. Chopped fibers 38 may be loaded into hopper 40 by a batch process or by continuous feed. Inlet 42 supplies a carrier fluid (such as air) to hopper 40 under pressure. The carrier fluid is used to propel fibers through shooter 46 out nozzle 36 into the cloth.

If a batch process is used, hopper 40 may be preloaded with chopped fibers 38 before the carrier fluid is supplied through inlet 42. If a continuous feed process is used, chopped fibers 38 may be added to the carrier fluid upstream of inlet 42 or chopped fibers 38 may be introduced to hopper 40 by a separate “feed” line.

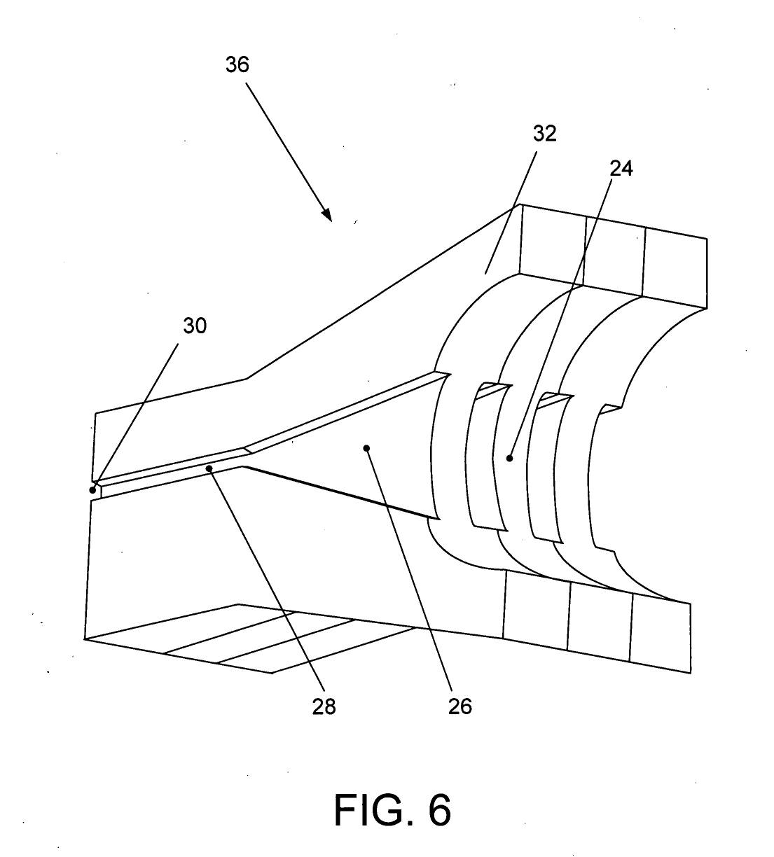

Nozzle 36 is illustrated in greater detail in FIG. 6. Nozzle 36 includes a series of alignment plates 32 that are stacked on top of each other. These alignment plates are used to align the fiber in a perpendicular orientation with respect to the cloth before propelling the fibers out of the shooter. As illustrated in FIG. 6, each alignment plate 32 has funnel 26 and conduit 28 milled on its front and back surfaces. When alignment plates 32 are stacked on top of each other as shown, chamber 24 is formed on one end. A round chamber that is properly ported will produce a vortex for dispersion of fibers and will reduce clogging. Funnels 26 of adjacent plates form ports in chamber 24 for receiving the fibers. Funnels 26 are two-dimensional funnels which taper towards conduit 28. A two-dimensional funnel is preferred over a round funnel to reduce the likelihood of clogging (i.e. two fibers passing through conduit 28 simultaneously). Each conduit 28 is small enough in width so that the fibers travel coaxially with respect to conduit 28 and exit the shooter through port 30 without having the tendency to turn sideways.

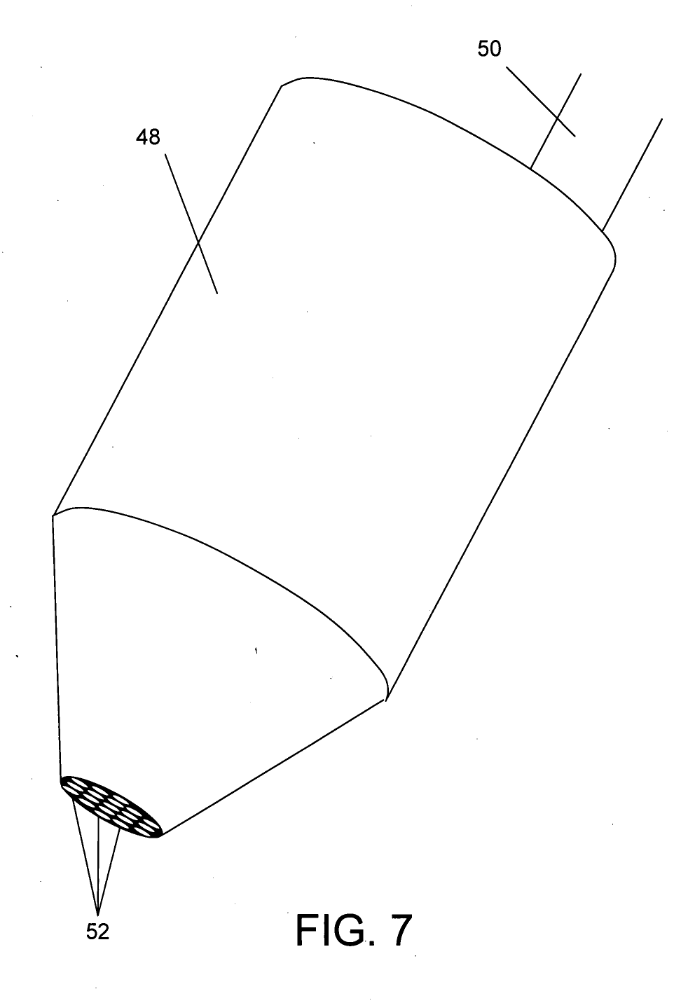

An alternate embodiment of a shooter is illustrated in FIG. 7. Fluid feed line 50, which supplies a carrier fluid to shooter 48, is attached on one end of shooter 48. Discharge ports 52 are provided on the opposite end of shooter 48 for discharging chopped fibers out of shooter 48 in the carrier fluid supplied through fluid feed line 50.

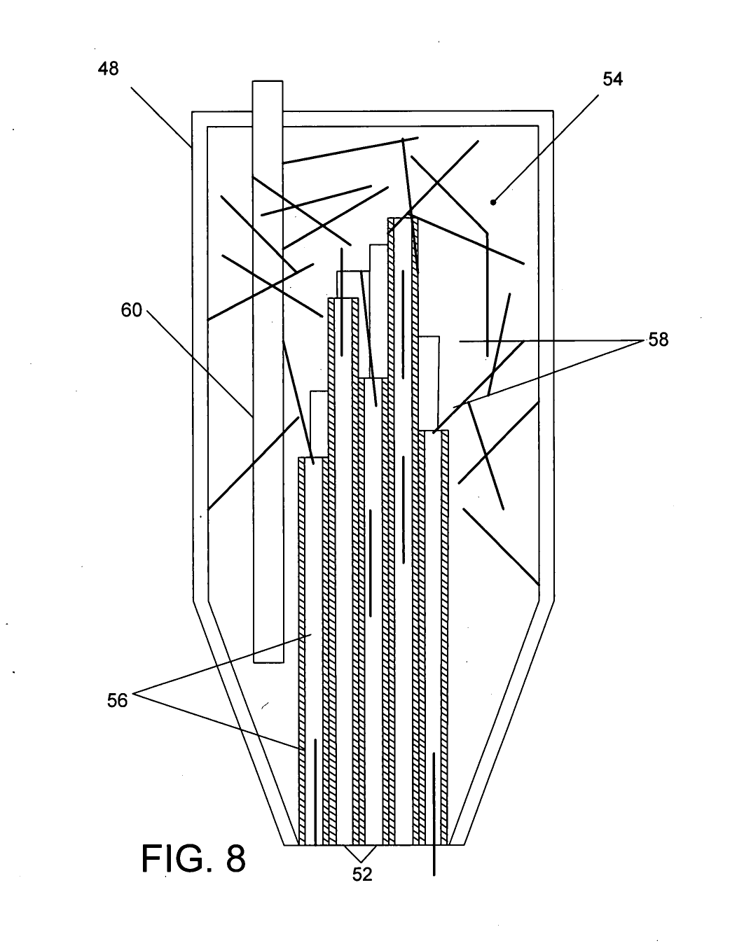

FIG. 8 is a section view of shooter 48. Fluid feed tube 60 is fluidly connected with fluid feed line 50 and directs the carrier fluid toward the opposite end of shooter 48. The reflection of the carrier fluid off of the opposite end of shooter 48 causes chopped fibers 58 to “float” within hopper 54. A plurality of discharge tubes 56 are provided in the interior of hopper 54. Discharge tubes 56 have different lengths to reduce clogging. The carrier fluid pulls chopped fibers 58 into discharge tubes and propels the fibers out of discharge ports 52 at a high velocity. The interior of discharge tubes 56 may be tapered near discharge ports 52 (like a venturi) to accelerate chopped fibers 58 before they exit shooter 48.

The length of the fibers and design of the shooter should be tuned to the specific application. For example, the fiber length will most often be determined by cloth thickness and the level of penetration needed. In general, fibers should be between 0.125 inches and 0.500 inches in length to properly penetrate two layers. Fibers may need to be even longer, however, if the object is to penetrate multiple layers. Similarly, the geometry of the shooter and the air pressure used may be varied to achieve the desired depth of fabric penetration. The proximity of the shooter to the fabric may also be varied.

In addition, fluids other than air may be used where deeper penetration is required. For example, acetone or isopropyl alcohol may be used to propel fibers through the shooter. These liquids would evaporate quickly after impregnation. Acetone may be particularly effective because acetone has no effect on the sizing on carbon fiber. The force of the liquid flow will open up the weave and allow the shot fibers to penetrate the weave regardless of the orientation of the fibers upon exiting the shooter. The fibers, however, will be driven through the cloth in the Z direction performing the ultimate objective.

Furthermore, the carrier fluid may be supplied to the shooter at a constant feed pressure or in “pressure pulses” that are timed with the movement of the shooter. For example, if an automated process is used, the shooter may be attached to an automated control arm. The control arm can move the shooter in the X and Y directions, and the shooter can shoot chopped fibers in the Z direction at various locations. Pauses in the movement of the control arm can be timed with pressure pulses to impregnate Z-axis fibers at the desired locations in the cloth.

The preceding description contains significant detail regarding the novel aspects of the present invention. It should not be construed, however, as limiting the scope of the invention but rather as providing illustrations of the preferred embodiments of the invention. For example, the fibers and matting may comprise any structural fiber material including Kevlar or fiberglass. The present invention is not limited to carbon fiber applications. Such variations do not alter the function of the present invention. Thus, the scope of the invention should be fixed by the claims, rather than by the examples given.

Having described my invention, I claim:

1. A method of manufacturing a reinforced composite material, comprising the steps of:
a. providing a first textile and a second textile, each of said first textile and said second textile having a plurality of fibers attached together and lying substantially in a common plane;
b. providing a plurality of chopped fibers;
c. providing a shooter having a discharge port, said shooter configured to discharge said plurality of chopped fibers through said discharge port;
d. arranging said first textile such that said common plane lies in a first plane;
e. aligning said shooter with said first textile; and
f. discharging said plurality of chopped fibers from said shooter in a carrier fluid through said discharge port such that said plurality of chopped fibers penetrate said first textile in a substantially perpendicular direction with respect to said first plane.

2. The method of claim 1, further comprising the steps of:
a. aligning said second textile in a second plane, said second plane substantially parallel with said first plane;
b. discharging said plurality of said chopped fibers from said shooter in said carrier fluid through said discharge port such that said plurality of chopped fibers penetrate said first textile and said second textile in a substantially perpendicular direction with respect to said first plane and said second plane.

3. The method of claim 1, said shooter having a hopper fluidly connected with said discharge port, said hopper configured to contain said plurality of chopped fibers before said plurality of chopped fibers are discharged through said discharge port.

4. The method of claim 1, wherein said carrier fluid is air.

5. The method of claim 1, wherein said first textile, said second textile, and said chopped fibers each comprise carbon fiber.

6. The method of claim 1, said shooter comprising a plurality of discharge ports fluidly connected with a hopper, said hopper configured to contain said plurality of chopped fibers before said plurality of chopped fibers are discharged through said plurality of discharge ports.

7. The method of claim 6, said shooter further comprising a plurality of discharge tubes, each of said plurality of discharge tubes fluidly having a first end connected with one of said plurality of discharge ports, each of said plurality of discharge tubes having a second end extending into said hopper.

8. The method of claim 7, wherein said plurality of discharge tubes have a varying length.

9. The method of claim 7, said shooter further comprising a fluid feed tube configured to discharge said carrier fluid into said hopper, said fluid feed tube extending within said hopper and terminating at a depth between said first ends of said plurality of discharge tubes and said second ends of said plurality of discharge tubes.

10. A method of manufacturing a reinforced composite material, comprising the steps of:
a. providing a first textile and a second textile, said first textile having a first plurality of fibers attached together in a first common plane, said second textile having a second plurality of fibers attached together in a second common plane;
b. providing a plurality of chopped fibers;
c. providing a shooter having an inlet and a discharge port, said shooter configured to discharge said plurality of chopped fibers through said discharge port;
d. arranging said first textile such that said first common plane lies in a first plane;
e. aligning said shooter with said first textile;
f. supplying a carrier fluid to said shooter through said inlet; and
f. discharging said plurality of chopped fibers from said shooter in said carrier fluid through said discharge port in a direction substantially perpendicular to said first plane such that said plurality of chopped fibers penetrate and embed in said first textile.

11. The method of claim 10, further comprising the steps of:
a. arranging said second textile in alignment with said first textile such that said second common plane lies in a second plane, said second plane substantially parallel with said first plane;
b. discharging said plurality of chopped fibers from said shooter in said carrier fluid through said discharge port in a substantially perpendicular direction with respect to said first plane and said second plane such that said plurality of chopped fibers penetrate and embed in said first textile and said second textile, thereby attaching said first textile to said second textile.

12. The method of claim 10, said shooter having a hopper fluidly connected with said discharge port, said hopper configured to contain said plurality of chopped fibers before said plurality of chopped fibers are discharged through said discharge port.

13. The method of claim 10, wherein said carrier fluid is air.

14. The method of claim 10, wherein said first textile, said second textile, and said chopped fibers each comprise carbon fiber.

15. The method of claim 10, said shooter comprising a plurality of discharge ports fluidly connected with a hopper, said hopper configured to contain said plurality of chopped fibers before said plurality of chopped fibers are discharged through said plurality of discharge ports.

16. The method of claim 15, said shooter further comprising a plurality of discharge tubes, each of said plurality of discharge tubes fluidly having a first end connected with one of said plurality of discharge ports, each of said plurality of discharge tubes having a second end extending into said hopper.

17. The method of claim 16, wherein said plurality of discharge tubes have a varying length.

18. The method of claim 16, said shooter further comprising a fluid feed tube configured to discharge said carrier fluid into said hopper, said fluid feed tube extending within said hopper and terminating at a depth between said first ends of said plurality of discharge tubes and said second ends of said plurality of discharge tubes.
